(19) United States
(12) Patent Application Publication
(10) Pub. No.: US 2026/0177870 A1
(43) Pub. Date: Jun. 25, 2026

(54) ELECTRO-OPTICAL DEVICE AND ELECTRONIC APPARATUS

(71) Applicant: SEIKO EPSON CORPORATION, Tokyo (JP)

(72) Inventors: Naoto KODAIRA, CHINO-SHI (JP); Yuki YASHIRO, CHITOSE-SHI (JP)

(73) Assignee: SEIKO EPSON CORPORATION, Tokyo (JP)

(21) Appl. No.: 19/422,478

(22) Filed: Dec. 17, 2025

(30) Foreign Application Priority Data
Dec. 19, 2024 (JP) 2024-223800

(51) Int. Cl. G02F 1/1362; G03B 21/00

(52) U.S. Cl. CPC G02F 1/13624; G02F 1/136295; G03B 21/006

(57) ABSTRACT

An electro-optical device includes a pixel region, a peripheral region located around the pixel region, and further includes a substrate, a plurality of first transistors located in the pixel region, a plurality of second transistors located in the peripheral region, a first insulating layer disposed above the first transistors and the second transistors, a plurality of first conductive portions located in the pixel region, disposed in the first insulating layer, and separated from each other, and a plurality of second conductive portions located in the peripheral region, and separated from each other, wherein in a plan view viewed in a thickness direction of the substrate, an arrangement density of the plurality of second conductive portions in a region occupied by the plurality of second conductive portions is higher than an arrangement density of the plurality of first conductive portions in a region occupied by the plurality of first conductive portions.

The present application is based on, and claims priority from JP Application Serial Number 2024-223800, filed December 19, 2024, the disclosure of which is hereby incorporated by reference herein in its entirety.

### BACKGROUND

### 1. Technical Field

The present disclosure relates to an electro-optical device and an electronic apparatus.

### 2. Related Art

An electronic apparatus such as a projector uses, for example, an electro-optical device such as a liquid crystal display device capable of changing optical characteristics pixel by pixel.

A substrate for an electro-optical device described in JP-A-11-72804 has a pixel region and a peripheral region located around the pixel region. In the pixel region, a transistor is provided for each pixel, and contacts in charge of connection to various wiring lines are coupled to the transistor. In the peripheral region, a peripheral circuit including a transistor disposed in the same layer as that of the transistors in the pixel region is disposed. Contacts in charge of connection to various wiring lines are also coupled to the transistor provided to the peripheral circuit.

JP-A-11-72804 is an example of the related art.

In the related art, when forming the contacts or the like that couple the transistor and various wiring lines to each other, there is a possibility that a global step or the like occurs between the pixel region and the peripheral region to make the connection with the contacts insufficient. As a result of a keen study by the disclosers, it has been found out that the step is caused by a planar density difference of the contacts or the like between the pixel region and the peripheral region.

### SUMMARY

An aspect of an electro-optical device according to the present disclosure is an electro-optical device including a pixel region having a pixel electrode and a peripheral region located around the pixel region, and further including a substrate, a plurality of first transistors located in the pixel region, a plurality of second transistors located in the peripheral region, a first insulating layer disposed above the first transistors and the second transistors, a plurality of first conductive portions located in the pixel region, disposed in the first insulating layer, and separated from each other, and a plurality of second conductive portions located in the peripheral region, disposed in the first insulating layer, and separated from each other, wherein in a plan view viewed in a thickness direction of the substrate, an arrangement density of the plurality of second conductive portions in a region occupied by the plurality of second conductive portions is higher than an arrangement density of the plurality of first conductive portions in a region occupied by the plurality of first conductive portions.

An aspect of an electronic apparatus according to the present disclosure includes an electro-optical device and a controller configured to control an operation of the electro-optical device.

### BRIEF DESCRIPTION OF THE DRAWINGS

FIG. 1 is a plan view of an electro-optical device according to an embodiment.

FIG. 2 is a cross-sectional view along the line A-A of the electro-optical device shown in FIG. 1.

FIG. 3 is a diagram schematically showing a peripheral circuit in the electro-optical device in FIG. 1.

FIG. 4 is an equivalent circuit diagram showing an electrical configuration in each pixel of an element substrate in FIG. 1.

FIG. 5 is a plan view showing a part of a pixel region in FIG. 1.

FIG. 6 is a diagram corresponding to a cross-section along the line B1-B1 in FIG. 5.

FIG. 7 is a diagram corresponding to a cross-section along the line B2-B2 in FIG. 5.

FIG. 8 is a plan view showing some of a plurality of second transistors provided to the peripheral circuit shown in FIG. 3.

FIG. 9 is a cross-sectional view showing the plurality of second transistors provided to the peripheral circuit shown in FIG. 3 and the vicinity thereof.

FIG. 10 is a cross-sectional view illustrating a relationship among arrangement densities of first, second, third, and fourth contacts.

FIG. 11 is a plan view illustrating the arrangement density of the first contacts in FIG. 6.

FIG. 12 is a plan view illustrating the arrangement density of the second contacts in FIG. 9.

FIG. 13 is a plan view illustrating the arrangement density of the third contacts in FIG. 6.

FIG. 14 is a plan view illustrating the arrangement density of the fourth contacts in FIG. 9.

FIG. 15 is a diagram illustrating a method of manufacturing an insulation layer illustrated in FIG. 10.

FIG. 16 is a diagram illustrating a method of manufacturing the third and fourth contacts illustrated in FIG. 10.

FIG. 17 is a diagram illustrating a method of manufacturing the third and fourth contacts illustrated in FIG. 10.

FIG. 18 is a cross-sectional view showing a fourth contact and a conductive portion in a first modified example.

FIG. 19 is a cross-sectional view showing a fourth contact and a conductive portion in a second modified example.

FIG. 20 is a cross-sectional view showing first and second contacts in a third modified example.

FIG. 21 is a diagram illustrating a method of manufacturing the first and second contacts illustrated in FIG. 20.

FIG. 22 is a diagram illustrating a method of manufacturing an insulation layer illustrated in FIG. 20.

FIG. 23 is a perspective view showing a personal computer as an example of an electronic apparatus.

FIG. 24 is a plan view showing a smartphone as an example of the electronic apparatus.

FIG. 25 is a schematic diagram showing a projector as an example of the electronic apparatus.

### DESCRIPTION OF EMBODIMENTS

A preferred embodiment according to the present disclosure will hereinafter be described with reference to the accompanying drawings. Note that in the drawings, dimensions and scales of components are different from the actual ones as appropriate and some portions are schematically illustrated in order to facilitate understanding. Further, the scope of the present disclosure is not limited to the embodiment unless there is a description that particularly limits the present disclosure in the following description.

### A. Electro-Optical Device

### A1. Basic Configuration

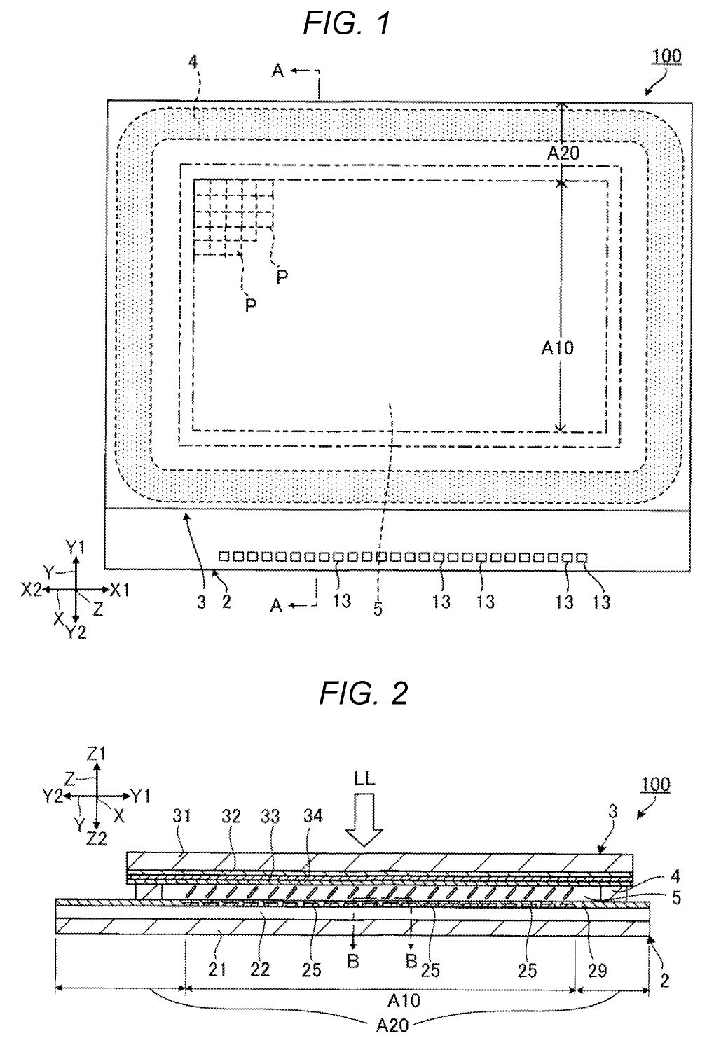

FIG. 1 is a plan view of an electro-optical device 100 according to the embodiment. FIG. 2 is a cross-sectional view along the line A-A of the electro-optical device 100 shown in FIG. 1. The description will hereinafter be presented using an X axis, a Y axis, and a Z axis orthogonal to each other as appropriate for the sake of convenience of the explanation. Further, one of directions along the X axis is described as an X1 direction, and a direction opposite to the X1 direction is described as an X2 direction. Similarly, one of directions along the Y axis is described as a Y1 direction, and a direction opposite the Y1 direction is described as a Y2 direction. One of directions along the Z axis is described as a Z1 direction, and a direction opposite the Z1 direction is described as a Z2 direction. Further, the Z axis is typically a vertical axis. The Z1 direction is an upper side, and the Z2 direction is a lower side. However, the Z axis is not required to be a vertical axis.

The electro-optical device 100 shown in FIGS. 1 and 2 is a transmissive electro-optical device of an active matrix drive system. The electro-optical device 100 includes an element substrate 2, an opposed substrate 3, a sealing member 4 shaped like a frame, and a liquid crystal layer 5. As shown in FIG. 2, the element substrate 2, the liquid crystal layer 5, and the opposed substrate 3 are arranged in this order in the Z1 direction. Further, a planar shape of the electro-optical device 100 shown in FIG. 1 is a quadrangular shape, but may instead be a polygonal shape other than the quadrangular shape, or a circular shape.

The element substrate 2 shown in FIG. 2 includes a first substrate 21 having a light-transmissive property, a laminated body 22 having a light-transmissive property, a plurality of pixel electrodes 25 having a light-transmissive property, and a first orientation film 29 having a light-transmissive property. The first substrate 21, the laminated body 22, the plurality of pixel electrodes 25, and the first orientation film 29 are stacked on one another in this order in the Z1 direction. Therefore, the laminated body 22 is disposed between the first substrate 21 and the plurality of pixel electrodes 25. Note that the term "light-transmissive property" means a light-transmissive property with respect to visible light, and means that the transmittance for the visible light is preferably no lower than 50%.

The first substrate 21 corresponds to a "substrate". A view from the Z1 direction or the Z2 direction, which is the thickness direction of the first substrate 21, is defined as a "plan view". The first substrate 21 is a flat plate having a light-transmissive property and an insulating property, and is configured with, for example, a glass substrate or a quartz substrate. The laminated body 22 includes a plurality of insulating films having a light-transmissive property. Further, the laminated body 22 is provided with various types of wiring lines and so on. The pixel electrodes 25 are each used to apply an electric field to the liquid crystal layer 5. The pixel electrodes 25 contain, for example, a transparent electrically-conductive material such as indium tin oxide (ITO), indium zinc oxide (IZO), or fluorine-doped tin oxide (FTO). Note that, although not shown, the element substrate 2 includes a plurality of dummy pixel electrodes that surround the plurality of pixel electrodes 25 in the plan view. Further, the first orientation film 29 has a light-transmissive property and an insulating property. The first orientation film 29 orients the liquid crystal molecules provided to the liquid crystal layer 5 in a specific direction. The first orientation film 29 is disposed so as to cover the plurality of pixel electrodes 25. The material of the first orientation film 29 is, for example, polyimide or silicon oxide.

The opposed substrate 3 is disposed so as to be opposed to the element substrate 2. The opposed substrate 3 includes a second substrate 31 having a light-transmissive property, an inorganic insulating layer 32 having a light-transmissive property, a common electrode 33 having a light-transmissive property, and a second orientation film 34 having a light-transmissive property. Further, although not illustrated, the opposed substrate 3 includes a partition that has a light-blocking property and surrounds the plurality of pixel electrodes 25 in the plan view. Note that the term "light-blocking property" means a light-blocking property with respect to the visible light, and means that the transmittance for the visible light is preferably lower than 50 %, and more preferably no higher than 10 %.

The second substrate 31, the inorganic insulating layer 32, the common electrode 33, and the second orientation film 34 are stacked on one another in this order in the Z2 direction. The second substrate 31 is a flat plate having a light-transmissive property and an insulating property, and is configured with, for example, a glass substrate or a quartz substrate. The inorganic insulating layer 32 has a light-transmissive property and an insulating property, and is made of, for example, an inorganic material containing silicon such as silicon oxide. The common electrode 33 is an opposed electrode disposed so as to face the plurality of pixel electrodes 25 via the liquid crystal layer 5. The common electrode 33 is used to apply electric fields to the liquid crystal layer 5. The common electrode 33 has a light-transmissive property and an electrically-conductive property. The common electrode 33 contains a transparent electrically-conductive material such as ITO, IZO, or FTO. The second orientation film 34 has a light- transmissive property and an insulating property. The second orientation film 34 orients the liquid crystal molecules provided to the liquid crystal layer 5 in a specific direction. The material of the second orientation film 34 is, for example, polyimide or silicon oxide.

The sealing member 4 is disposed between the element substrate 2 and the opposed substrate 3. The sealing member 4 is formed using an adhesive containing various types of curable resins such as epoxy resin. The sealing member 4 may include a gap member formed of an inorganic material such as glass.

The liquid crystal layer 5 is disposed in a region surrounded by the element substrate 2, the opposed substrate 3, and the sealing member 4. The liquid crystal layer 5 is an electro-optical layer the optical characteristics of which change in accordance with the electric field. The liquid crystal layer 5 contains liquid crystal molecules having positive or negative dielectric anisotropy. The orientation of the liquid crystal molecules changes in accordance with a voltage applied to the liquid crystal layer 5.

Such an electro-optical device 100 includes a pixel region A10 and a peripheral region A20 located around the pixel region A10 in the plan view. The pixel region A10 is a region where an image is displayed, and is provided with a plurality of pixels P arranged in a matrix. The plurality of pixel electrodes 25 is arranged so as to correspond one-to-one to the plurality of pixels P. The common electrode 33 described above is provided in common to the plurality of pixels P. Further, the peripheral region A20 surrounds the pixel region A10 in the plan view.

In the present embodiment, the electro-optical device 100 is of a transmissive type. Specifically, as shown in FIG. 2, light LL is modulated during a period after entering the opposed substrate 3 and before exiting the element substrate 2 to thereby display an image. Note that an image may be displayed by modulating the light having entered the element substrate 2 before the light is emitted from the opposed substrate 3.

Further, the electro-optical device 100 is applied to a display apparatus that performs color display, such as a personal computer or a smartphone described later. When the electro-optical device 100 is applied to that display apparatus, a color filter is used in the electro-optical device 100 as appropriate. Further, the electro-optical device 100 is also applied to, for example, a projection type projector described later. In this case, the electro-optical device 100 functions as a light valve. Note that in this case, the color filter is omitted from the electro-optical device 100.

### A2. Peripheral Circuit

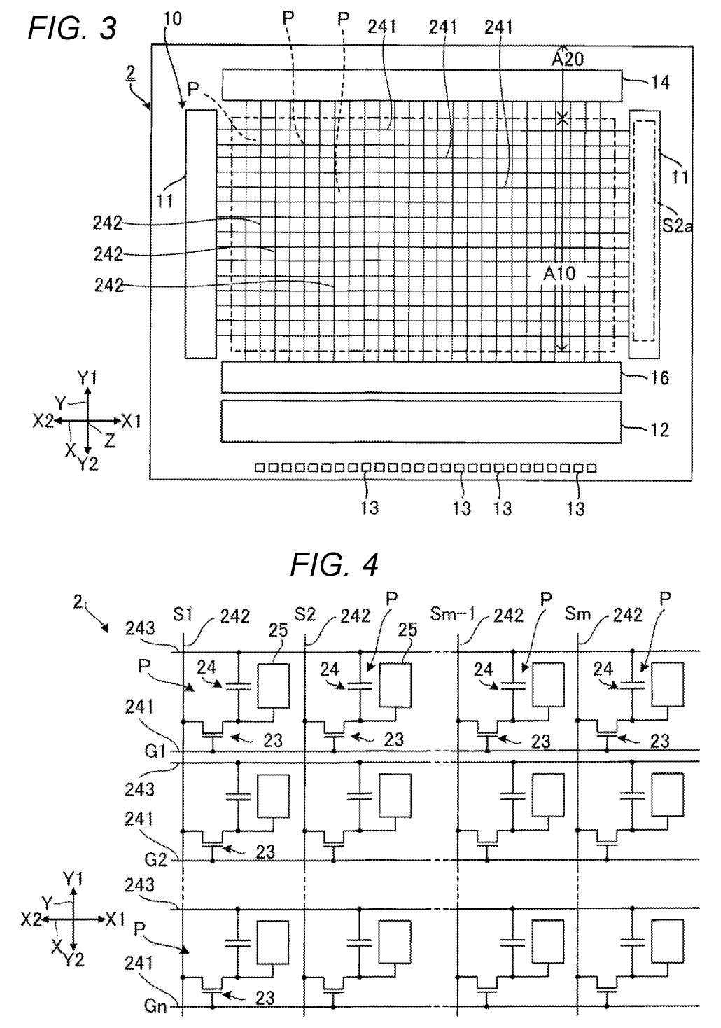

FIG. 3 is a diagram schematically illustrating a peripheral circuit 10 in the electro-optical device 100 in FIG. 1. As illustrated in FIG. 3, the peripheral circuit 10 and a plurality of external terminals 13 are disposed in the peripheral region A20 of the electro-optical device 100. The plurality of external terminals 13 is coupled to wiring lines (not illustrated) laid around from the peripheral circuit 10.

Further, in the pixel region A10, n scan lines 241 and m data lines 242 are arranged. The characters n and m are each integers no smaller than 2. The n scan lines 241 extend in a direction along the X axis and are arranged at regular intervals in a direction along the Y axis. The m data lines 242 extend in a direction along the Y axis and are arranged at regular intervals in a direction along the X axis. The n scan lines 241 and the m data lines 242 are electrically insulated from each other and arranged in a lattice in the plan view. A region surrounded by two adjacent scan lines 241 and two adjacent data lines 242 corresponds to the pixel P.

Further, the peripheral circuit 10 includes two scan-line drive circuits 11, a data-line drive circuit 12, an inspection circuit 14, and a sampling circuit 16.

In the illustrated example, the two scan-line drive circuits 11 are disposed across the pixel region A10. The scan-line drive circuit 11 includes a plurality of transistors. For example, the scan lines 241 in odd-numbered rows are driven by the scan-line drive circuit 11 disposed at the left side of the pixel region A10, and the scan lines 241 in even-numbered rows are driven by the scan-line drive circuit 11 disposed at the right side of the pixel region A10. Note that the same scan line 241 may be driven by the scan-line drive circuits 11 disposed at both sides.

The inspection circuit 14 is disposed at, for example, an opposite side of the pixel region A10 to the plurality of external terminals 13. The data lines 242 are coupled to the inspection circuit 14. The inspection circuit 14 is used to inspect an operation defect or the like of the electro-optical device 100 by detecting image signals at the time of manufacturing or shipping the electro-optical device 100. The inspection circuit 14 includes, for example, transistors provided respectively to the data lines 242. One of source-drain regions provided to the transistor is electrically coupled to the data line 242, and the other of the source-drain regions is coupled to an inspection line (not illustrated). In addition, a gate of each of the transistors is electrically coupled to a control signal line (not illustrated).

The data-line drive circuit 12 and the sampling circuit 16 are disposed at, for example, an opposite side of the pixel region A10 to the inspection circuit 14. The data-line drive circuit 12 is electrically coupled to the m data lines 242 via the sampling circuit 16. The data-line drive circuit 12 includes, for example, an inverter circuit and a transmission gate, and has a plurality of transistors.

In addition, the sampling circuit 16 samples the image signals based on the sampling signal output from the data-line drive circuit 12 and supplies the data lines 242 with the image signals thus sampled.

The sampling circuit 16 includes transistors provided respectively to the data lines 242. One of source-drain regions provided to the transistor is electrically coupled to the data line 242, and the other of the source-drain regions is coupled to a constant potential line (not illustrated). In addition, a gate of each transistor is electrically coupled to a signal line (not illustrated) to which the sampling signal is supplied.

### A3. Electrical Configuration in Each Pixel P in Pixel Region A10

FIG. 4 is an equivalent circuit diagram showing an electrical configuration in each pixel P of the element substrate 2 in FIG. 1. As illustrated in FIG. 4, in the pixel region A10 of the element substrate 2, the first transistor 23, the pixel electrode 25, and the capacitive element 24 are provided for each pixel P. The first transistors 23 each include a gate, a source, and a drain. The pixel electrode 25 is electrically coupled to the drain of the corresponding first transistor 23. Further, in the pixel region A10, as described above, n constant potential lines 243 are arranged in addition to the n scan lines 241 and the m data lines 242.

The n scan lines 241 are each electrically coupled to the gate of corresponding one of the plurality of first transistors 23. Scan signals G1, G2, ..., and Gn are supplied in a line sequential manner from the scan-line drive circuits 11 described above to first to n-th scan lines 241.

The m data lines 242 are each electrically coupled to the source of corresponding one of the plurality of first transistors 23. First to m-th data lines 242 are supplied with the image signals S1, S2, ..., and Sm in parallel from the data-line drive circuit 12 described above via the sampling circuit 16.

The n constant potential lines 243 extend in the X1 direction and are arranged at regular intervals in the Y2 direction. Further, the n constant potential lines 243 are electrically insulated from the n scan lines 241 and the m data lines 242, and are arranged at distances from these lines. A constant potential Vcom is applied to the constant potential lines 243. The n constant potential lines 243 are each electrically coupled to one of two electrodes provided to the corresponding capacitive element 24. Further, the other of the two electrodes provided to each of the capacitive elements 24 is electrically coupled to the corresponding pixel electrode 25. The capacitive elements 24 are each a holding capacitance that holds the potential of the pixel electrode 25. The constant potential Vcom is applied to the one electrode of the capacitive element 24, and the other electrode is electrically coupled to the drain of the first transistor 23.

When the scan signals G1, G2, ..., and Gn are sequentially activated to sequentially select the n scan lines 241, the transistors 23 coupled to the scan lines 241 thus selected are set to an ON state. Then, the image signals S1, S2, ..., and Sm having magnitudes according to grayscales to be displayed are captured into the pixels P corresponding to the scan lines 241 thus selected via the m data lines 242, and are applied to the pixel electrodes 25. Thus, a voltage according to the grayscale to be displayed is applied to a liquid crystal capacitance formed between the pixel electrode 25 and the common electrode 33 in FIG. 2, and thus, the orientation of the liquid crystal molecules changes in accordance with the voltage applied. Further, the voltage applied is held by the capacitive element 24. The light is modulated by such a change in the orientation of the liquid crystal molecules to make it possible to perform gradation display.

### A4. Configuration of Each Pixel P in Pixel Region A10

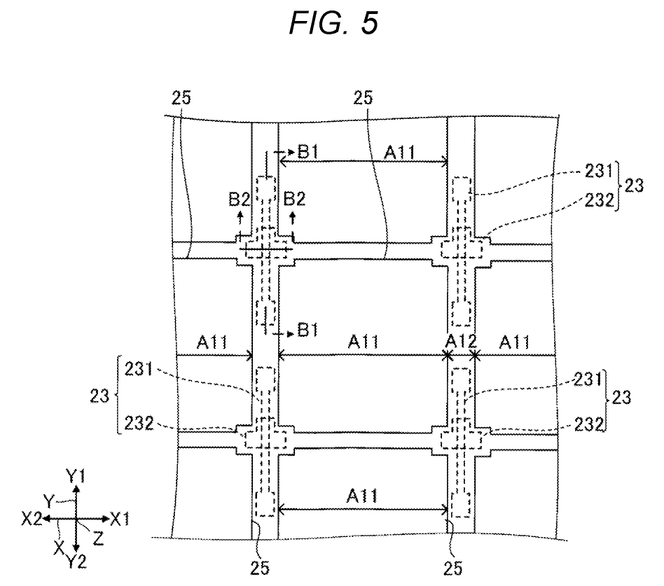

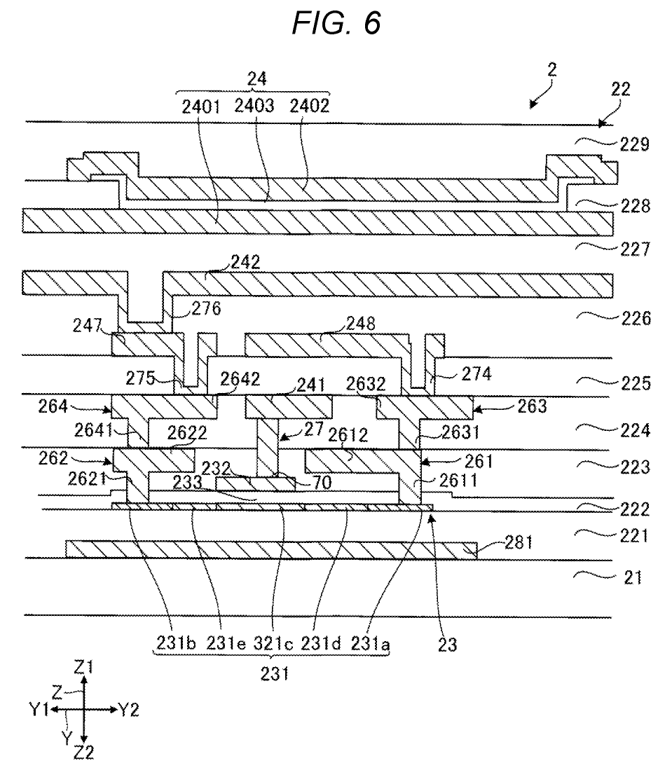

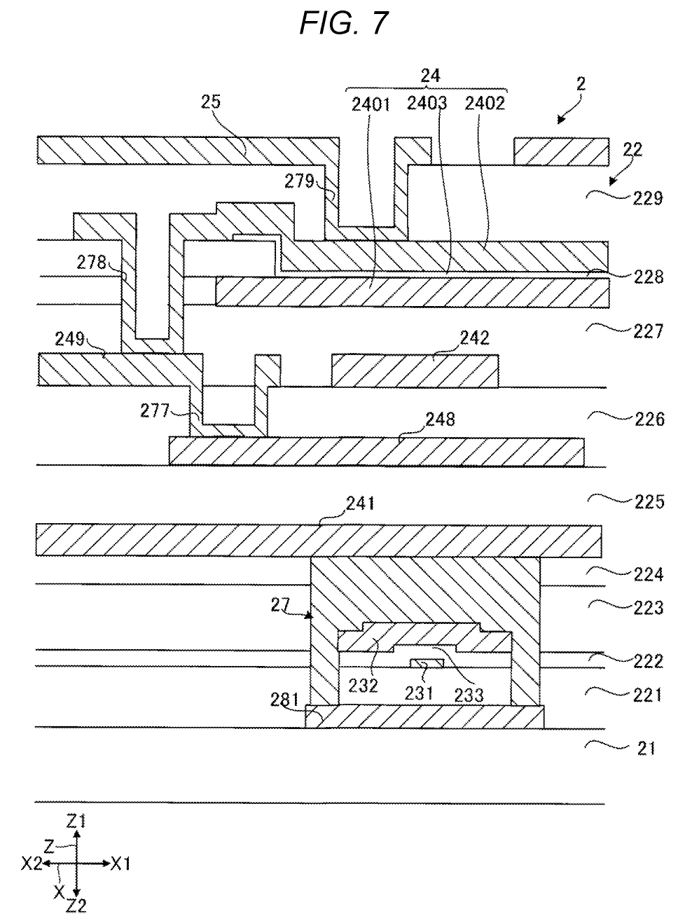

FIG. 5 is a plan view showing a part of the pixel region A10 in FIG. 1. FIG. 6 is a diagram corresponding to a cross-section along the line B1-B1 in FIG. 5. FIG. 7 is a diagram corresponding to a cross-section along the line B2-B2 in FIG. 5.

As shown in FIG. 5, the pixel region A10 includes a plurality of opening regions A11 and a light blocking region A12. The plurality of opening regions A11 is arranged in a matrix in the plan view. The shape in the plan view of the light blocking region A12 is like a frame located between the plurality of opening regions A11. The opening regions A11 are each a region in which the pixel electrode 25 is disposed and through which the light is transmitted. Meanwhile, the first transistors 23 are disposed in the light blocking region A12. Although not shown in FIG. 5, a plurality of wiring lines such as the scan lines 241, the data lines 242, and the constant potential lines 243 shown in FIG. 4, and the capacitive elements 24 are disposed in the light blocking region A12.

As illustrated in FIGS. 6 and 7, the laminated body 22 of the element substrate 2 includes the insulating layers 221, 222, 223, 224, 225, 226, 227, 228, and 229 described above. The insulating layers 222 and 223 correspond to a "first insulating layer". The insulating layer 224 corresponds to a "second insulating layer".

A light blocking portion 281 is disposed on the first substrate 21. The light blocking portion 281 is provided to prevent light from entering a semiconductor layer 231 of the first transistor 23. Note that the first substrate 21 may have a recessed portion that opens toward the Z1 direction. In this case, the light blocking portion 281 may be disposed in that recessed portion.

The first transistor 23 is disposed on the insulating layer 221. The first transistor 23 includes the semiconductor layer 231, a gate electrode 232, and a gate insulating film 233. The semiconductor layer 231 is disposed on the insulating layer 221. The gate electrode 232 is disposed on the insulating layer 222. The gate insulating film 233 is interposed between the gate electrode 232 and the semiconductor layer 231. In the insulating layer 222, a region corresponding to the gate electrode 232 in the plan view forms the gate insulating film 233.

The first transistor 23 has a lightly doped drain (LDD) structure. The semiconductor layer 231 includes a drain region 231a, a source region 231b, a channel region 231c, a low-concentration drain region 231d, and a low-concentration source region 231e. The channel region 231c is located between the drain region 231a and the source region 231b. The low-concentration drain region 231d is located between the channel region 231c and the drain region 231a. The low-concentration source region 231e is located between the channel region 231c and the source region 231b. Note that, for example, the first transistor 23 is not required to have the LDD structure, and the low-concentration source region 231e and the low-concentration drain region 231d may be omitted. The semiconductor layer 231 overlaps the light blocking portion 281 in the plan view.

The semiconductor layer 231 is made of, for example, polysilicon. The drain region 231a and the source region 231b are doped with impurities. Further, the gate electrode 232 is formed by, for example, doping polysilicon with impurities that increase electrical conductivity. Note that the gate electrode 232 may be formed using an electrically-conductive material such as metal, a metal oxide, or a metal compound. Further, the gate insulating film 233 is configured with a silicon oxide film deposited by, for example, thermal oxidation or chemical vapor deposition (CVD).

First contacts 261 and 262 are provided in the insulating layers 222 and 223. The first contact 261 is provided so as to correspond to the first transistor 23. The first contact 261 is a contact coupled to the drain region 231a. The first contact 261 includes a first columnar portion 2611 and a first upper portion 2612. The first columnar portion 2611 is a portion coupled to the drain region 231a. The first columnar portion 2611 is a columnar portion embedded in a hole penetrating the insulating layers 222 and 223. The first upper portion 2612 is a portion shaped like a flat plate that is coupled to the first columnar portion 2611 and extends along an X-Y plane.

The first contact 262 is provided so as to correspond to the first transistor 23. The first contact 262 includes a first columnar portion 2621 and a first upper portion 2622. The first columnar portion 2621 is a portion coupled to the source region 231b. The first columnar portion 2621 is a columnar portion embedded in a hole penetrating the insulating layers 222 and 223. The first upper portion 2622 is a portion shaped like a flat plate that is coupled to the first columnar portion 2621 and extends along the X-Y plane.

The scan line 241, a contact 27, a third contact 263, and a third contact 264 are arranged in the insulating layer 224. As described above, the scan line 241 is electrically coupled to the gate electrode 232 via the contact 27. Further, as shown in FIG. 7, the contact 27 is coupled to the light blocking portion 281. Note that the contact 27 and the scan line 241 are separately formed, but may be integrally formed of the same material.

The third contact 263 is provided so as to correspond to the first transistor 23. The third contact 263 includes a third columnar portion 2631 and a third upper portion 2632. The third columnar portion 2631 is a portion coupled to the drain region 231a via the first contact 261. The third columnar portion 2631 is a columnar portion embedded in a hole penetrating the insulating layer 224. The third upper portion 2632 is a portion shaped like a flat plate that is coupled to the third columnar portion 2631 and extends along the X-Y plane.

The third contact 264 is provided so as to correspond to the first transistor 23. The third contact 264 includes a third columnar portion 2641 and a third upper portion 2642. The third columnar portion 2641 is a portion coupled to the source region 231b via the first contact 262.

The third columnar portion 2641 is a columnar portion embedded in a hole penetrating the insulating layer 224. The third upper portion 2642 is a portion shaped like a flat plate that is coupled to the third columnar portion 2641 and extends along the X-Y plane.

Although the plan view is omitted, in the present embodiment, the third contact 263 is provided so as to correspond one-to-one to the first contact 261. Similarly, the third contact 264 is provided so as to correspond one-to-one to the first contact 262.

Further, each of the first contact 261 and the contact 27 functions as a light blocking portion that suppresses incidence of light on the low-concentration drain region 231d of the semiconductor layer 231. By providing the first contact 261, the contact 27, and the light blocking portion 281, the incidence of light on the low-concentration drain region 231d of the semiconductor layer 231 can be suppressed.

As shown in FIG. 6, a relay electrode 247 and a relay electrode 248 are disposed on the insulating layer 225. The relay electrode 247 is electrically coupled to the relay electrode 246 via a contact 275 penetrating the insulating layer 225. Note that the contact 275 has, for example, a trench structure that is formed integrally with the relay electrode 246 and is disposed along an inner wall surface of a hole formed in the insulating layer 225. Further, the relay electrode 248 is electrically coupled to a relay electrode 245 via a contact 274 penetrating the insulating layer 225. Note that the contact 274 has a trench structure that is formed integrally with the relay electrode 248 and is disposed along an inner wall surface of a hole formed in the insulating layer 225.

The data line 242 is disposed on the insulating layer 226. The data line 242 is electrically coupled to the relay electrode 247 via a contact 276 penetrating the insulating layer 226. Note that the contact 276 has a trench structure that is formed integrally with the data line 242 and is disposed along an inner wall surface of a hole formed in the insulating layer 226.

As shown in FIG. 7, a relay electrode 249 is disposed on the insulating layer 226. The relay electrode 249 is electrically coupled to the relay electrode 248 via a contact 277 penetrating the insulating layer 226. Note that the contact 277 has a trench structure that is formed integrally with the relay electrode 249 and is disposed along an inner wall surface of a hole formed in the insulating layer 226.

The capacitive element 24 is disposed on the insulating layer 227. The capacitive element 24 includes a pair of electrodes 2401 and 2402 and a dielectric layer 2403. The electrode 2401 is disposed on the insulating layer 227. The electrode 2402 is disposed on the insulating layer 228. The dielectric layer 2403 is disposed between the electrode 2401 and the electrode 2402. The electrode 2401 also serves as the constant potential line 243 in FIG. 4. Further, the electrode 2402 is electrically coupled to the relay electrode 249 via a contact 278 penetrating the insulating layers 227 and 228. Note that the contact 278 has a trench structure that is formed integrally with the electrode 2402 and is disposed along an inner wall surface of a hole formed in the insulating layers 227 and 228.

The pixel electrode 25 is disposed on the insulating layer 229. The pixel electrode 25 is electrically coupled to the electrode 2402 via a contact 279 penetrating the insulating layer 229. Note that the contact 279 has a trench structure that is formed integrally with the pixel electrode 25 and is disposed along an inner wall surface of a hole formed in the insulating layer 229.

The scan line 241, the data line 242, the relay electrodes 247, 248, and 249 described above each contain, for example, metal such as tungsten (W), titanium (Ti), chromium (Cr), iron (Fe), or aluminum (Al), a metal nitride, or a metal silicide. These may each be a monolayer or a laminate. For example, these are each configured with a laminated body of an aluminum film and a titanium nitride film.

Each of the first contact 261, the first contact 262, the third contact 263, and the third contact 264 described above contains, for example, metal such as tungsten (W), titanium (Ti), chromium (Cr), iron (Fe), or aluminum (Al), a metal nitride, or a metal silicide. These may each be a monolayer or a laminate.

Further, the contacts 274 to 279 described above each contain, for example, metal such as tungsten (W), titanium (Ti), chromium (Cr), iron (Fe), or aluminum (Al), a metal nitride, or a metal silicide. The contacts 274 to 279 may each be a monolayer or a laminate. Further, the contacts 274 to 279 may each be formed integrally with or may be formed separately from the electrode or the wiring line coupled thereto. Each of the contacts 274 to 279 may have a trench structure or may be a contact plug.

Note that a configuration of the element substrate 2 shown in FIGS. 6 and 7 is illustrative only. For example, another capacitive element than the capacitive element 24 may be provided. Further, the scan line 241, the data line 242, and the capacitive element 24 are arranged in this order in the Z1 direction, but are not required to be arranged in this order.

### A5. Peripheral Circuit 10

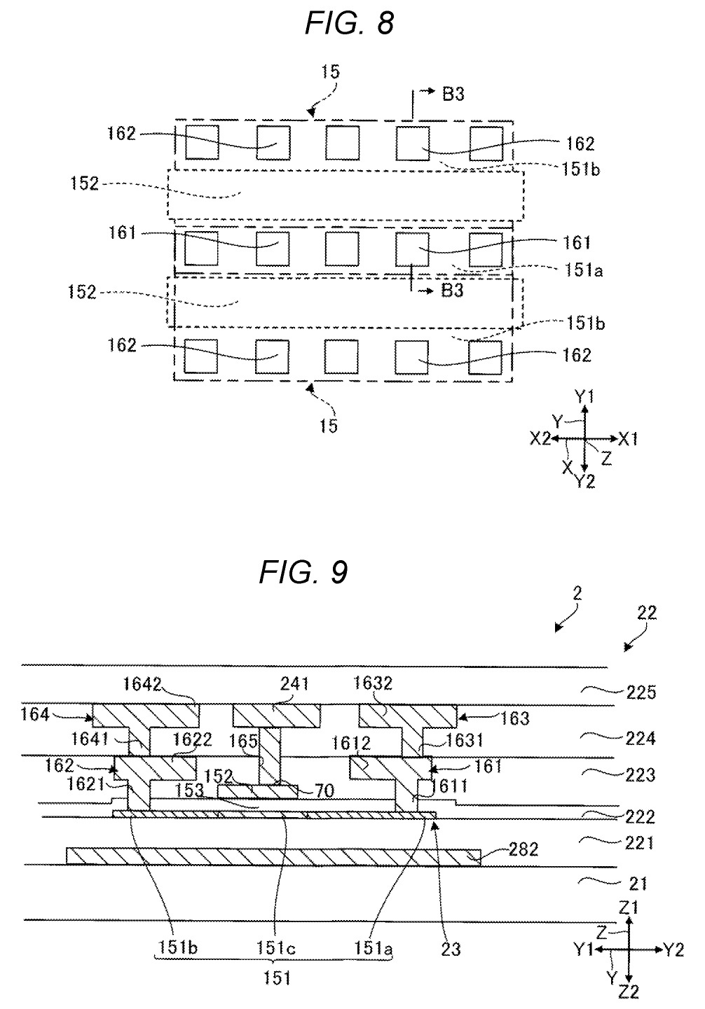

FIG. 8 is a plan view illustrating a part of a plurality of second transistors 15 provided to the peripheral circuit 10 illustrated in FIG. 3. FIG. 9 is a cross-sectional view illustrating the plurality of second transistors 15 provided to the peripheral circuit 10 illustrated in FIG. 3 and the vicinity of the plurality of second transistors 15. FIG. 9 corresponds to a cross-section along a line B3-B3 in FIG. 8. Hereinafter, for example, a part of the scan-line drive circuit 11 in the peripheral circuit 10 is illustrated.

As illustrated in FIG. 9, in the peripheral region A20, a light blocking portion 282 is disposed on the first substrate 21. The light blocking portion 282 is a film having a light blocking property. The light blocking portion 282 is provided in order to suppress incidence of light on the semiconductor layer 151 provided to the corresponding second transistor 15. Note that the first substrate 21 may have a recessed portion that opens toward the Z1 direction. In this case, the light blocking portion 282 may be disposed in that recessed portion. In addition, the light blocking portion 282 may be provided so as to correspond one-to-one to the second transistor 15, or may be provided every two or more second transistors 15.

The second transistor 15 is disposed on the insulating layer 221. The second transistor 15 includes a semiconductor layer 151, a gate electrode 152, and a gate insulating film 153. The gate insulating film is disposed between the semiconductor layer 151 and the gate electrode 152. The semiconductor layer 151 is disposed on the insulating layer 221, and the gate electrode 152 is disposed on the insulating layer 222. The semiconductor layer 151 includes a source-drain region 151a, a source-drain region 151b, and a channel region 151c. The channel region 151c is located between the source-drain region 151a and the source-drain region 151b. Note that the "source-drain region" is a region including either one of a source and a drain.

The semiconductor layer 151 is made of, for example, polysilicon. The source-drain region 151a and the source-drain region 151b are doped with impurities. Further, the gate electrode 152 is formed by, for example, doping polysilicon with impurities that increase electrical conductivity. Note that the gate electrode 152 may be formed using an electrically-conductive material such as metal, a metal oxide, or a metal compound. Further, the gate insulating film 153 is configured with a silicon oxide film deposited by, for example, thermal oxidation or CVD.

In addition, a plurality of second transistors 15 is provided, and is arranged side by side along the X axis or the Y axis, for example. In FIG. 8, two second transistors 15 are illustrated. In the example shown in FIG. 8, two second transistors 15 share a part with each other. Specifically, the two second transistors 15 share the source-drain region 151a provided to the two second transistors 15.

As shown in FIG. 9, the insulating layers 222 and 223 have second contacts 161 and 162. The second contact 161 is a contact coupled to the source-drain region 151a. The second contact 161 is provided so as to correspond to the second transistor 15. The second contact 161 includes a second columnar portion 1611 and a second upper portion 1612. The second columnar portion 1611 is a portion coupled to the source-drain region 151a. The second columnar portion 1611 is a columnar portion embedded in a hole penetrating the insulating layers 222 and 223. The second upper portion 1612 is a portion shaped like a flat plate that is coupled to the second columnar portion 1611 and extends along the X-Y plane.

The second contact 162 is provided so as to correspond to the second transistor 15. The second contact 162 includes a second columnar portion 1621 and a second upper portion 1622. The second columnar portion 1621 is a portion coupled to the source-drain region 151b. The second columnar portion 1621 is a columnar portion embedded in a hole penetrating the insulating layers 222 and 223. The second upper portion 1622 is a portion shaped like a flat plate that is coupled to the second columnar portion 1621 and extends along the X-Y plane.

As illustrated in FIG. 8, a plurality of second contacts 161 is provided for one second transistor 15. Similarly, a plurality of second contacts 162 is provided for one second transistor 15. The plurality of second contacts 161 is arranged at a distance from each other along the X axis, and the plurality of second contacts 162 is arranged at a distance from each other along the X axis. Since the plurality of second contacts 161 and the plurality of second contacts 162 are provided for one second transistor 15, a plurality of columnar portions high in aspect ratio can be provided. Therefore, an increase in resistance of the second contacts 161 and 162 can be suppressed.

As illustrated in FIG. 9, the scan line 241, a contact 165, a fourth contact 163, and a fourth contact 164 are arranged in the insulating layer 224. As described above, the scan line 241 is electrically coupled to the gate electrode 152 via the contact 165. Note that the contact 165 and the scan line 241 are separately formed, but may be integrally formed of the same material.

The fourth contact 163 is provided so as to correspond to the second transistor 15. The fourth contact 163 includes a fourth columnar portion 1631 and a fourth upper portion 1632. The fourth columnar portion 1631 is a portion coupled to the source-drain region 151a via the second contact 161. The fourth columnar portion 1631 is a columnar portion embedded in a hole penetrating the insulating layer 224. The fourth upper portion 1632 is a portion shaped like a flat plate that is coupled to the fourth columnar portion 1631 and extends along the X-Y plane.

The fourth contact 164 is provided so as to correspond to the second transistor 15. The fourth contact 164 includes a fourth columnar portion 1641 and a fourth upper portion 1642. The fourth columnar portion 1641 is a portion coupled to the source-drain region 151b via the second contact 162. The fourth columnar portion 1641 is a columnar portion embedded in a hole penetrating the insulating layer 224. The fourth upper portion 1642 is a portion shaped like a flat plate that is coupled to the fourth columnar portion 1641 and extends along the X-Y plane.

Although the plan view is omitted, in the present embodiment, the fourth contact 163 is provided so as to correspond one-to-one to the second contact 161. Similarly, the fourth contact 164 is provided so as to correspond one-to-one to the second contact 162.

Note that although a configuration of layers higher than the insulating layer 225 is not illustrated, each of the fourth contact 164 and the fourth contact 163 is electrically coupled to various wiring lines not illustrated.

Further, each of the second contact 161, the second contact 162, the fourth contact 163, and the fourth contact 164 contains, for example, metal such as tungsten (W), titanium (Ti), chromium (Cr), iron (Fe), or aluminum (Al), a metal nitride, or a metal silicide. These may each be a monolayer or a laminate.

### A6. Density (Packing Density) of Conductive Portions

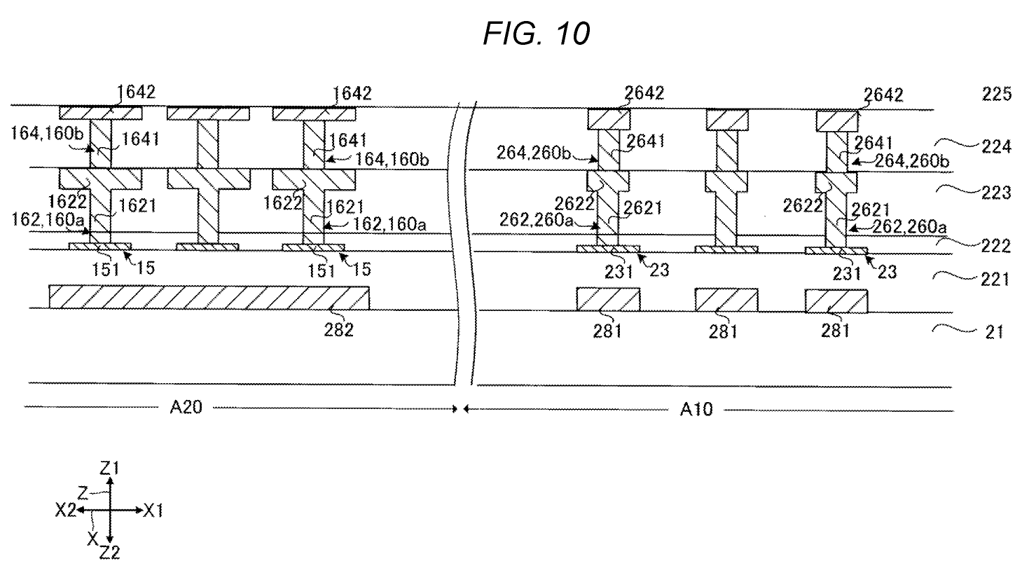

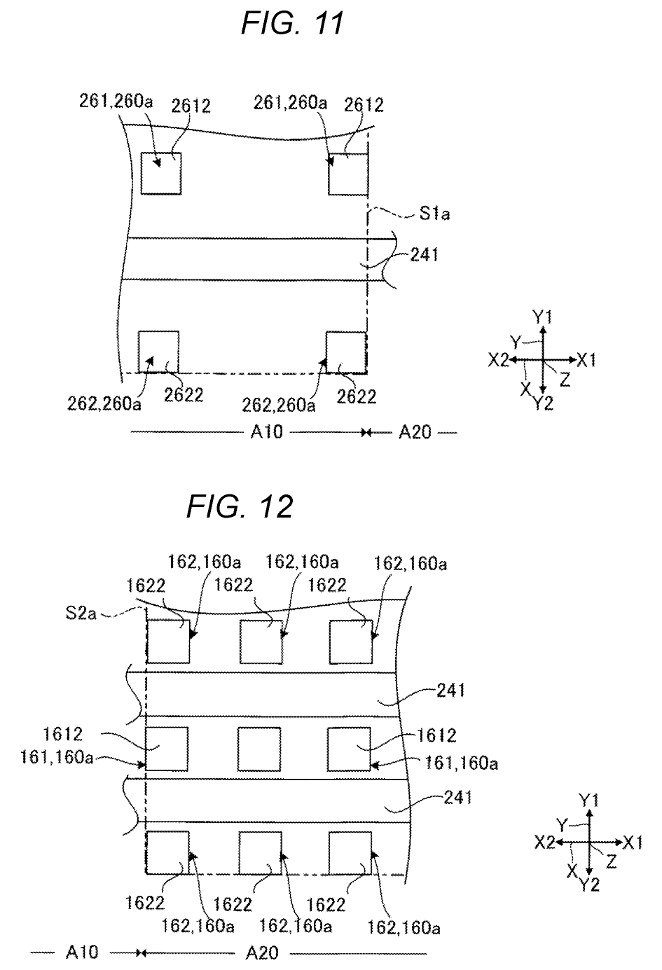

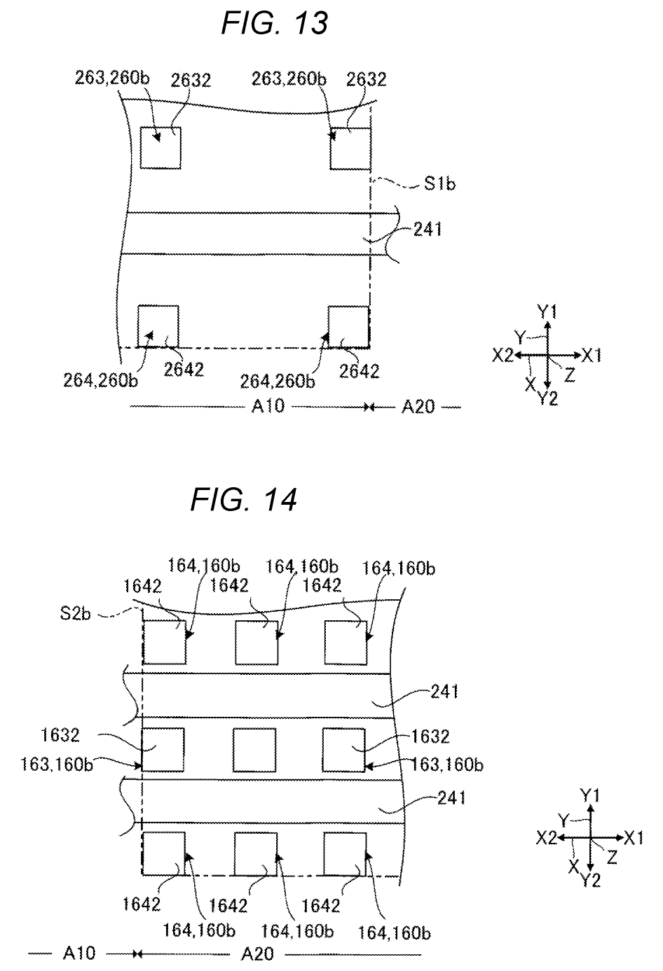

FIG. 10 is a cross-sectional view illustrating a relationship between arrangement densities (packing density) of first contacts 260a, second contacts 160a, third contacts 260b, and fourth contacts 160b. FIG. 11 is a plan view illustrating the arrangement density of the first contacts 261, 262 in FIG. 6. FIG. 12 is a plan view illustrating the arrangement density of the second contacts 161, 162 in FIG. 9. FIG. 13 is a plan view illustrating the arrangement density of the third contacts 263, 264 in FIG. 6. FIG. 14 is a plan view illustrating the arrangement density of the fourth contacts 163, 164 in FIG. 9.

Here, as described above, the plurality of first contacts 261 and the plurality of first contacts 262 are disposed in the pixel region A10. Further, the plurality of third contacts 263 and the plurality of third contacts 264 are disposed in the pixel region A10. Further, the plurality of second contacts 161 and the plurality of second contacts 162 are disposed in the peripheral region A20. Further, the plurality of fourth contacts 163 and the plurality of fourth contacts 164 are disposed in the peripheral region A20.

Note that the plurality of first contacts 261 and the plurality of first contacts 262 may hereinafter collectively be referred to as a "plurality of first contacts 260a" in some cases. The plurality of third contacts 263 and the plurality of third contacts 264 may collectively be referred to as a "plurality of third contacts 260b" in some cases. Further, the plurality of second contacts 161 and the plurality of second contacts 162 may collectively be referred to as a "plurality of second contacts 160a" in some cases. The plurality of fourth contacts 163 and the plurality of fourth contacts 164 may collectively be referred to as a "plurality of fourth contacts 160b" in some cases. The plurality of first contacts 260a is a "plurality of first conductive portions". The plurality of second contacts 160a is a "plurality of second conductive portions". The plurality of third contacts 260b is a "plurality of third conductive portions". The plurality of fourth contacts 160b is a "plurality of fourth conductive portions".

As is understood with reference to FIGS. 10, 11, and 12, the arrangement density of the plurality of second contacts 160a in a region S2a occupied by the plurality of second contacts 160a is higher than the arrangement density of the plurality of first contacts 260a in a region S1a occupied by the plurality of first contacts 260a in a plan view viewed in the thickness direction of the first substrate 21. That is, the arrangement density of the plurality of second contacts 160a is higher (denser) than the arrangement density of the plurality of first contacts 260a. The arrangement density is an area ratio of the first contacts 260a or the second contacts 160a per unit area. The arrangement density of the plurality of first contacts 260a is an index on how densely the plurality of first contacts 260a is disposed in the region S1a. The arrangement density of the plurality of second contacts 160a is an index on how densely the plurality of second contacts 160a is disposed in the region S2a.

The region S1a is a closed space formed along the outer edges of some first contacts 260a located at the outermost side out of the plurality of first contacts 260a arranged in the pixel region A10. The region S2a is a closed space formed along the outer edges of some second contacts 160a located at the outermost side out of the plurality of second contacts 160a. Note that an example of the region S2a is shown in FIG. 3.

Further, as is understood with reference to FIGS. 10, 13, and FIG. 14, the arrangement density of the plurality of fourth contacts 160b in a region S2b occupied by the plurality of fourth contacts 160b is higher than the arrangement density of the plurality of third contacts 260b in a region S1b occupied by the plurality of third contacts 260b in a plan view viewed in the thickness direction of the first substrate 21. That is, the arrangement density of the plurality of fourth contacts 160b is higher than the arrangement density of the plurality of third contacts 260b.

The region S2b is a closed space formed along the outer edges of some third contacts 260b located at the outermost side out of the plurality of third contacts 260b arranged in the pixel region A10. The region S1b is a closed space formed along the outer edges of some fourth contacts 160b located at the outermost side out of the plurality of fourth contacts 160b.

As described above, by setting the arrangement density of the plurality of second contacts 160a high, and setting the arrangement density of the plurality of fourth contacts 160b high, the global step at the time of manufacturing can be eliminated by thinning. Therefore, it is possible to reduce the possibility of occurrence of conduction failure due to the third contact 260b and the fourth contact 160b. Therefore, the reliability of the electro-optical device 100 can be improved.

Note that the scan line 241 is a wiring line that has electrical conductivity and is disposed in the insulating layer 224. However, the scan line 241 is arranged straddling a boundary between the peripheral region A20 and the pixel region A10. Therefore, the scan line 241 does not affect the magnitude relationship in difference between the arrangement densities described above, and is not considered.

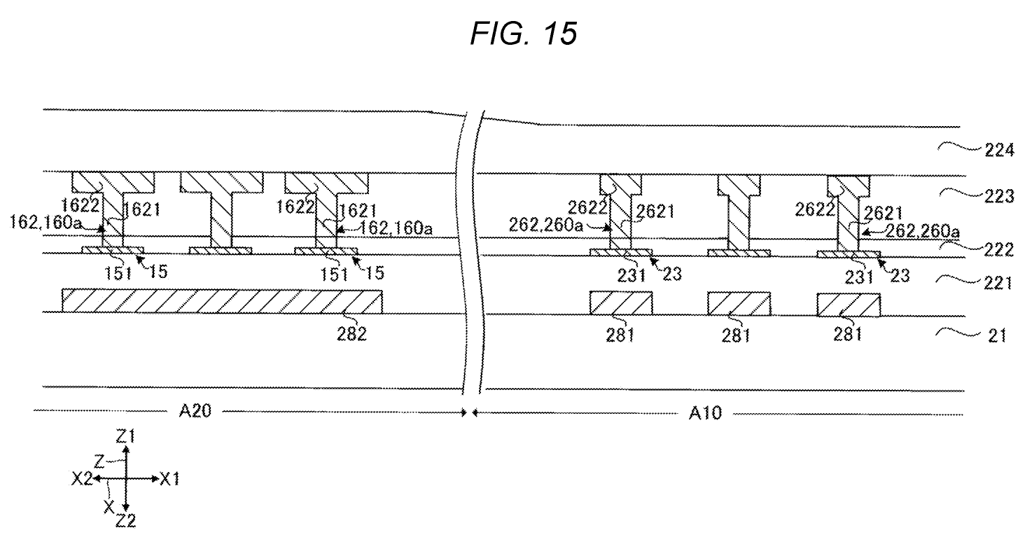

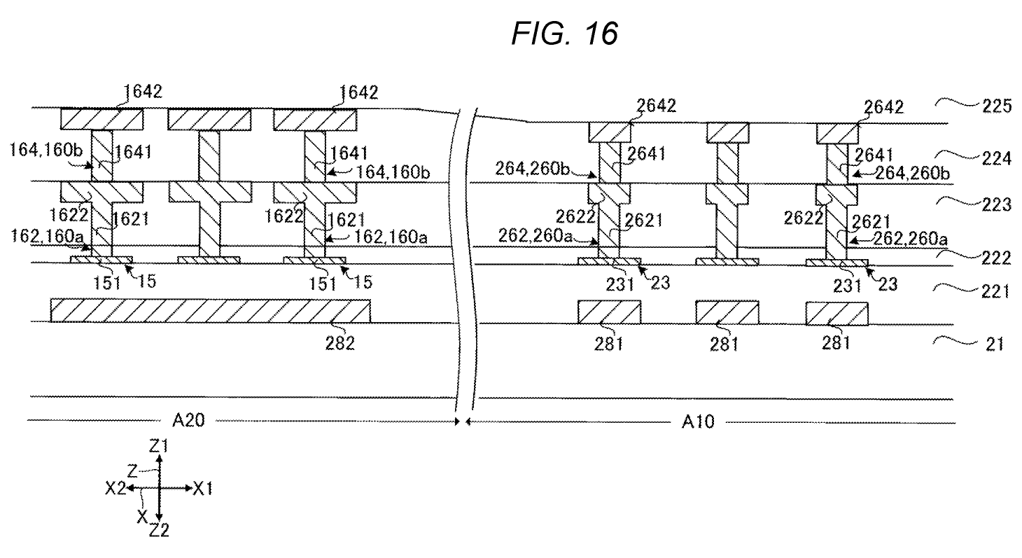

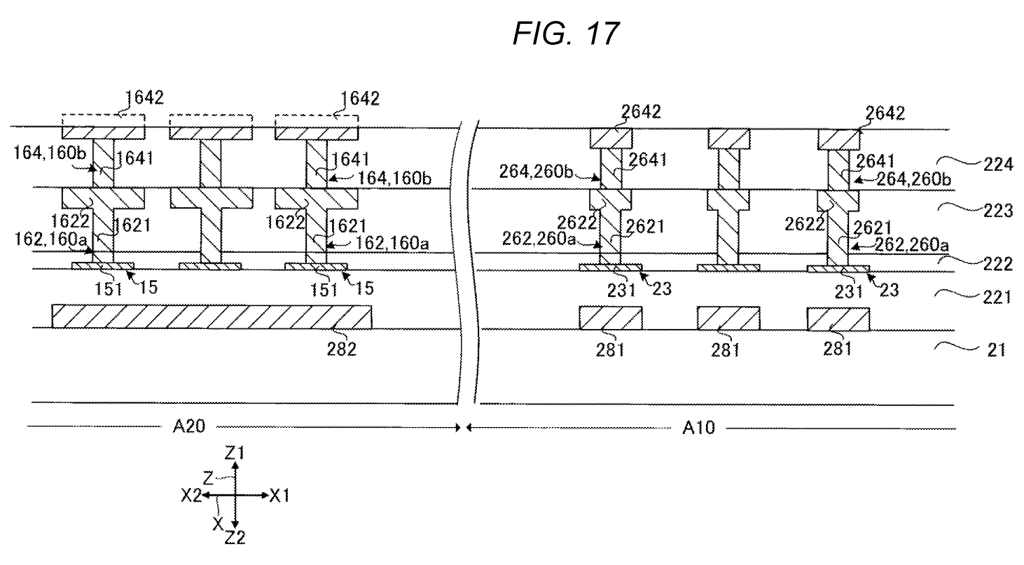

FIG. 15 is a diagram illustrating a method of manufacturing the insulating layer 224 shown in FIG. 10. FIGS. 16 and 17 are each a diagram illustrating a method of manufacturing the third contacts 260b and the fourth contacts 160b shown in FIG. 10.

As illustrated in FIG. 15, when planarization processing with chemical mechanical polishing (CMP) or the like is performed after the insulating layer 224 is deposited, a global step is generated on an upper surface of the insulating layer 224. The global step is a step generated between the pixel region A10 and the peripheral region A20. The arrangement density of the plurality of second contacts 160a is higher than the arrangement density of the plurality of first contacts 260a. Therefore, due to the planarization processing, an upper portion of the plurality of second contacts 160a in the insulating layer 224 protrudes upward from an upper portion of the plurality of first contacts 260a in the insulating layer 224.

Then, as shown in FIG. 16, the plurality of third contacts 260b and the plurality of fourth contacts 160b are formed in the insulating layer 224. The upper surfaces of the plurality of second contacts 160a in the insulating layer 224 are located above the upper surfaces of the plurality of first contacts 260a in the insulating layer 224. Therefore, the upper surfaces of the plurality of third contacts 260b are located above the upper surfaces of the plurality of fourth contacts 160b. In this state, the planarization processing such as CMP is performed on the plurality of third contacts 260b and the plurality of fourth contacts 160b. As a result, as shown in FIG. 17, the upper portion of each of the fourth contacts 160b is removed by thinning. Since the arrangement density of the plurality of fourth contacts 160b is higher than the arrangement density of the plurality of third contacts 260b, the plurality of fourth contacts 160b are easily removed by thinning compared to the plurality of third contacts 260b. Due to the thinning, the positions in the Z axis of the upper surfaces of the plurality of fourth contacts 160b and the plurality of third contacts 260b become substantially the same as each other. Therefore, the step on the insulating layer 224 is eliminated.

As described above, by setting the arrangement density of the plurality of second contacts 160a high, and setting the arrangement density of the plurality of fourth contacts 160b high, the step on the insulating layer 224 can be eliminated by thinning. Therefore, it is possible to improve the workability of various contacts to be arranged above the plurality of third contacts 260b and the plurality of fourth contacts 160b. Therefore, it is possible to make it difficult for coupling failure of the plurality of third contacts 260b and the plurality of fourth contacts 160b to various contacts to occur.

Further, the center-to-center distance between two adjacent second contacts 160a out of the plurality of second contacts 160a is preferably smaller than the center-to-center distance between two adjacent first contacts 260a out of the plurality of first contacts 260a. The center-to-center distance between two adjacent fourth contacts 160b out of the plurality of fourth contacts 160b is preferably smaller than the center-to-center distance between two adjacent third contacts 260b out of the plurality of third contacts 260b. Due to such a relationship of the center-to-center distance, as described above, the step on the insulating layer 224 can effectively be eliminated by thinning.

Further, as shown in FIG. 10, the plurality of second contacts 162 each has a second columnar portion 1621 and a second upper portion 1622. The plane area of the second upper portion 1622 is larger than the plane area of the second columnar portion 1621. By having such a second upper portion 1622, conduction between the second contact 162 and the fourth contact 164 is easily achieved. That is, it is possible to provide the second upper portion 1622 with a function as a relay electrode.

Similarly, the plurality of second contacts 161 each includes the second columnar portion 1611 and the second upper portion 1612. Therefore, the second contact 161 also provides substantially the same advantages as those of the second contact 162.

Further, as shown in FIG. 10, the plurality of first contacts 262 each has a first columnar portion 2621 and a first upper portion 2622. The plane area of the first upper portion 2622 is larger than the plane area of the first columnar portion 2621. By having such a first upper portion 2622, conduction between the first contact 262 and the third contact 264 is easily achieved. That is, it is possible to provide the first upper portion 2622 with a function as a relay electrode.

Similarly, the plurality of first contacts 261 each includes the first columnar portion 2611 and the first upper portion 2612. Therefore, the first contact 261 also provides substantially the same advantages as those of the first contact 262.

The arrangement density of the second upper portions 1612 and 1622 is higher than the arrangement density of the first upper portions 2612 and 2622. By adopting such a configuration, it is possible to provide a global step in the insulating layer 223 such that a portion corresponding to the peripheral region A20 out of the insulating layer 223 protrudes upward from a portion corresponding to the pixel region A10 out of the insulating layer 223.

Further, as shown in FIG. 10, the plurality of fourth contacts 164 each has the fourth columnar portion 1641 and the fourth upper portion 1642. The plane area of the fourth upper portion 1642 is larger than the plane area of the fourth columnar portion 1641. By having such a fourth upper portion 1642, it is easy to achieve conduction between the fourth contact 164 and a contact located above the fourth contact 164. That is, it is possible to provide the fourth upper portion 1642 with a function as a relay electrode.

Similarly, the plurality of fourth contacts 163 each includes the fourth columnar portion 1631 and the fourth upper portion 1632. Therefore, the fourth contact 163 also provides substantially the same advantages as those of the fourth contact 164.

Further, as shown in FIG. 10, the plurality of third contacts 264 each has the third columnar portion 2641 and the third upper portion 2642. The plane area of the third upper portion 2642 is larger than the plane area of the third columnar portion 2641. By having such a third upper portion 2642, it is easy to achieve conduction between the third contact 264 and a contact located above the third contact 264. That is, it is possible to provide the third upper portion 2642 with a function as a relay electrode.

Similarly, the plurality of third contacts 263 each includes the third columnar portion 2631 and the third upper portion 2632. Therefore, the third contact 263 also provides substantially the same advantages as those of the third contact 264.

The arrangement density of the fourth upper portions 1632 and 1642 is higher than the arrangement density of the third upper portions 2632 and 2642. By adopting such a configuration, the step of the upper surface of the insulating layer 224 can be eliminated by thinning.

Further, since thinning is used, the thickness along the Z axis of the fourth upper portion 1642 is smaller than the thicknesses along the Z axis of the third upper portions 2642 and 2632. Similarly, the thickness along the Z axis of the fourth upper portion 1632 is smaller than the thicknesses along the Z axis of the third upper portions 2642 and 2632.

Further, each of the third contacts 260b is shaped like a plug embedded in a through hole provided to the insulating layer 224. Similarly, each of the fourth contacts 160b is shaped like a plug embedded in a through hole provided to the insulating layer 223. Since the third contact 260b and the fourth contact 160b are shaped like a plug, the global step of the insulating layer 224 is easily eliminated by thinning as described above. In addition, since the third contact 260b and the fourth contact 160b are shaped like a plug, it is easy to achieve high definition compared to when the third contact 260b and the fourth contact 160b are a trench type disposed along a wall surface constituting the through hole.

Further, each of the third contacts 260b preferably contains tungsten. Similarly, each of the fourth contacts 160b preferably contains tungsten. By the third contact 260b and the fourth contact 160b containing tungsten, the embeddability of the through hole can be improved.

Further, the insulating layer 224 is preferably an inorganic material containing silicon such as a silicon oxide or a silicon oxynitride. By including such a material, thinning is easily caused by a polishing rate difference in CMP or the like from the fourth contact 160b containing tungsten. Therefore, the global step can be eliminated using the thinning.

Further, the difference in arrangement density between the plurality of first contacts 260a and the plurality of second contacts 160a is not particularly limited. Similarly, the difference in arrangement density between the plurality of third contacts 260b and the plurality of fourth contacts 160b is not particularly limited. The difference in arrangement density can appropriately be set in accordance with a step amount of the global step and a thinning amount.

### B. Modified Examples

The embodiment exemplified above can variously be modified. Specific aspects of modifications applicable to the embodiment described above will be exemplified below. Two or more aspects randomly selected from the following examples can be combined with each other as appropriate to the extent that no contradiction occurs.

### B1. First Modified Example

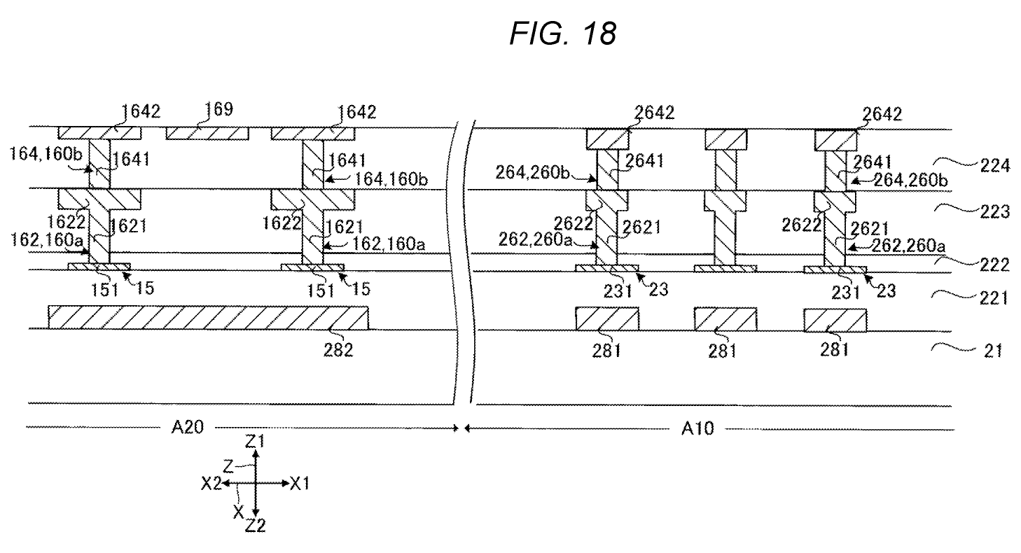

FIG. 18 is a cross-sectional view showing the fourth contacts 160b and a conductive portion 169 in a first modified example. As shown in FIG. 18, the conductive portion 169 is provided to the insulating layer 224. The conductive portion 169 corresponds to the "fourth conductive portion". Therefore, in the present modified example, the "plurality of fourth conductive portions" includes the fourth contacts 160b and the conductive portion 169. Further, the conductive portion 169 has a potential different from that of the fourth contacts 160b. In the present modified example, the conductive portion 169 is in a floating state. The conductive portion 169 is disposed at the same position in the Z axis as the fourth upper portion 1642. Similarly to the fourth upper portion 1642, the conductive portion 169 is shaped like a flat plate extending in the X-Y plane.

The conductive portion 169 is provided to adjust the thinning amount. When a target thinning amount cannot be obtained only by the fourth contacts 160b, the arrangement density of the "plurality of fourth conductive portions" can be adjusted by providing the conductive portion 169. Therefore, the global step can effectively be eliminated using the thinning.

### B2. Second Modified Example

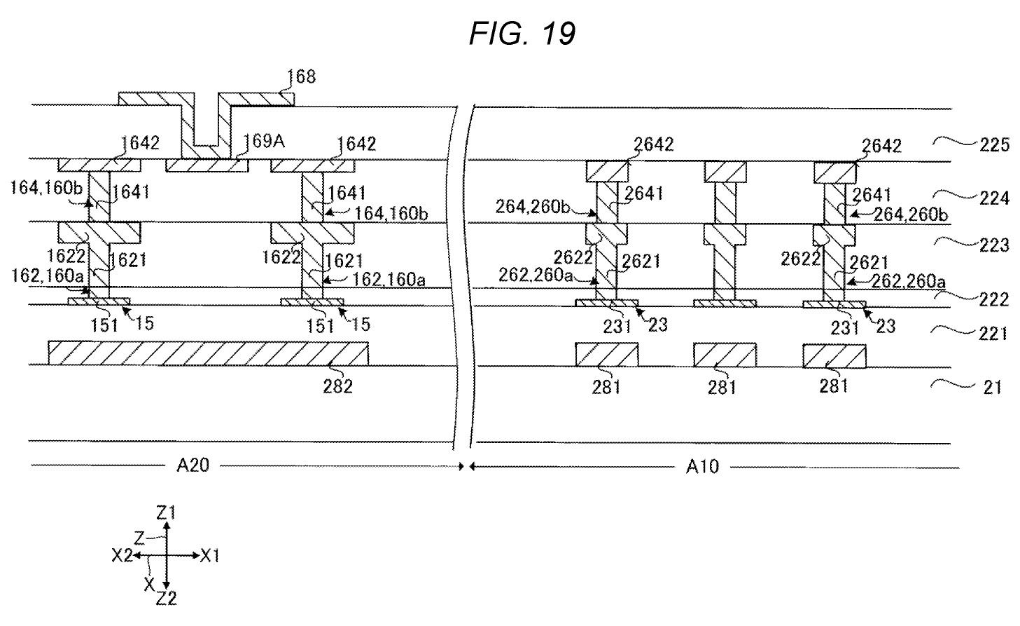

FIG. 19 is a cross-sectional view showing the fourth contacts 160b and a conductive portion 169A in a second modified example. As shown in FIG. 19, the conductive portion 169A is provided. Unlike the conductive portion 169 in the first modified example, the conductive portion 169A is coupled to a relay electrode 168 disposed in a layer above the conductive portion 169A. Such a conductive portion 169A has a potential different from that of the fourth contacts 160b. For example, the conductive portion 169A has a power supply potential or a reference potential. The reference potential is a potential serving as a reference of a potential supplied to each of the pixels P.

Such a conductive portion 169A can also effectively eliminate the global step using the thinning.

### B3. Third Modified Example

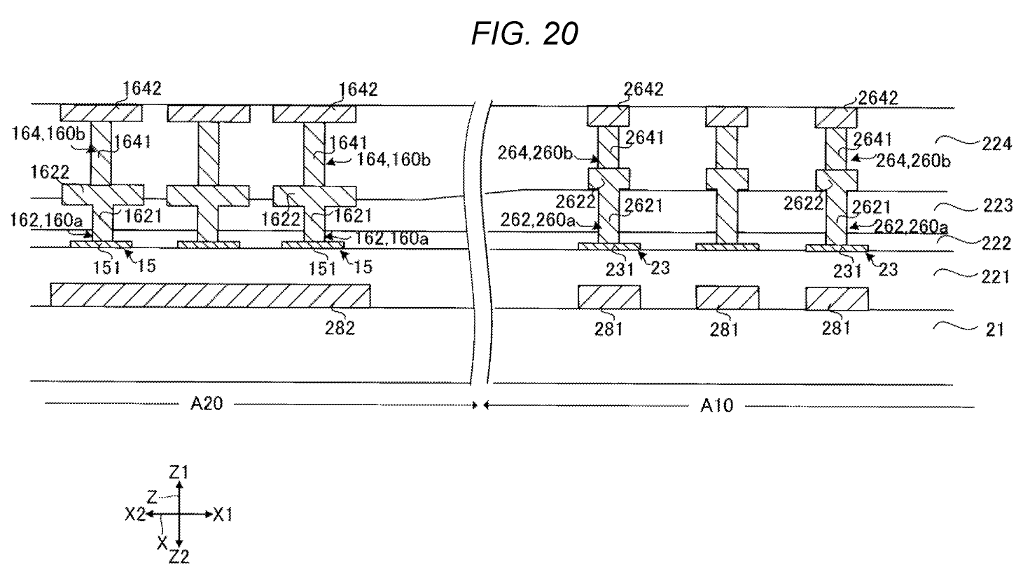

FIG. 20 is a cross-sectional view showing the first contacts 260a and the second contacts 160a in a third modified example. In FIG. 20, the upper surface of the insulating layer 223 has a step. In the present modified example, the upper surfaces of the plurality of second contacts 160a are located below the upper surfaces of the plurality of first contacts 260a. Further, a part of the second contact 160a is exposed upward from the insulating layer 223.

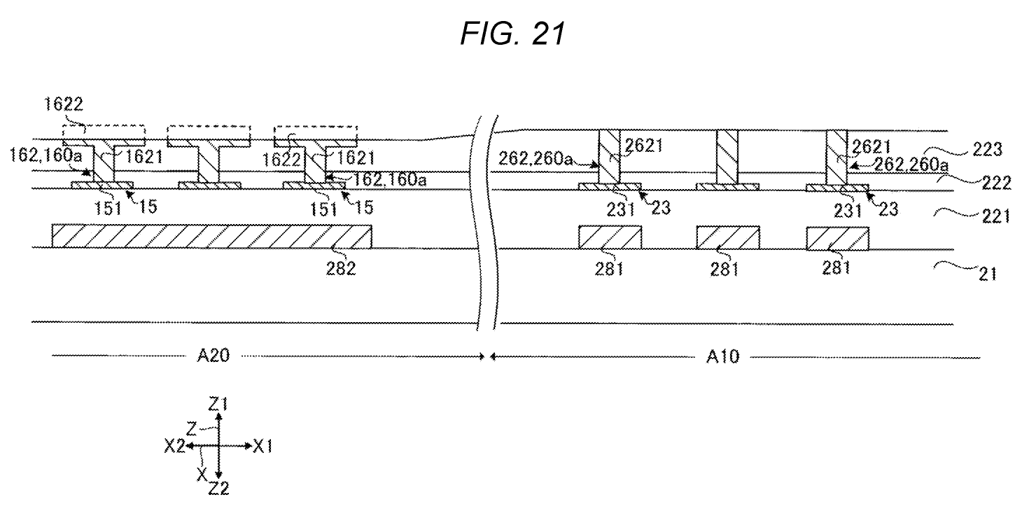

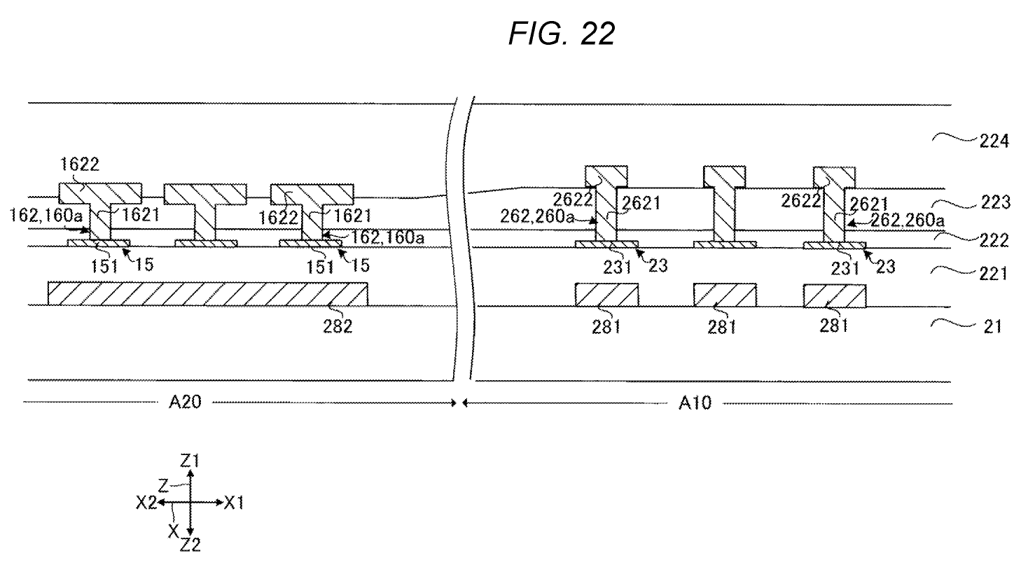

FIG. 21 is a diagram illustrating a method of manufacturing the first contacts 260a and the second contacts 160a shown in FIG. 20. FIG. 22 is a diagram illustrating a method of manufacturing the insulating layer 223 shown in FIG. 20.

According to the embodiment described above, the global step of the insulating layer 223 caused by the difference in arrangement density between the first contacts 260a and the second contacts 160a is eliminated by the difference in thinning amount caused by the difference in arrangement density between the third contacts 260b and the fourth contacts 160b to thereby eliminate the step of the upper surface of the insulating layer 224. In contrast, in the present modified example, the step of the upper surface of the insulating layer 224 is eliminated by using thinning when manufacturing the plurality of second contacts 160a and the plurality of first contacts 260a in consideration of the global step in the deposition of the insulating layer 224.

As shown in FIG. 21, a step is generated on the upper surface of the insulating layer 223 due to a difference in thinning amount caused by a difference in arrangement density between the first contacts 260a and the second contacts 160a. Therefore, for example, a part of the second upper portion 1622 is removed by CMP or the like. After the planarization processing with CMP or the like, a part of the second upper portion 1622 and the first upper portion 2622 are formed. Subsequently, as shown in FIG. 22, the insulating layer 224 is deposited. On this occasion, the step of the upper surface of the insulating layer 224 is eliminated by the global step of the insulating layer 224 due to the difference in arrangement density between the third contacts 260b and the fourth contacts 160b.

Also in the present modified example, similarly to the embodiment, the arrangement density of the plurality of second contacts 160a is higher than the arrangement density of the plurality of first contacts 260a. Therefore, thinning is used when manufacturing the plurality of second contacts 160a and the plurality of first contacts 260a in consideration of the global step in the deposition of the insulating layer 224. As a result, the step of the upper surface of the insulating layer 224 can be eliminated. Therefore, also in the present modified example, similarly to the embodiment, it is possible to reduce the possibility that the conduction failure due to the third contacts 260b and the fourth contacts 160b occurs. Therefore, the reliability of the electro-optical device 100 can be improved.

### B4. Other Modified Examples

In the embodiment described above, the electro-optical device 100 having the active matrix system is exemplified, but this is not a limitation, and the electro-optical device 100 may have, for example, a passive matrix system.

The drive system of the "electro-optical device" is not limited to a longitudinal electric field system, and may be a transverse electric field system. Note that examples of the transverse electric field system include an in-plane switching (IPS) mode. Further, examples of the longitudinal electric field system include a twisted nematic (TN) mode, a vertical alignment (VA) mode, a PVA mode, and an optically compensated bend (OCB) mode.

### C. Electronic Apparatus

The electro-optical device 100 can be used in various electronic apparatuses.

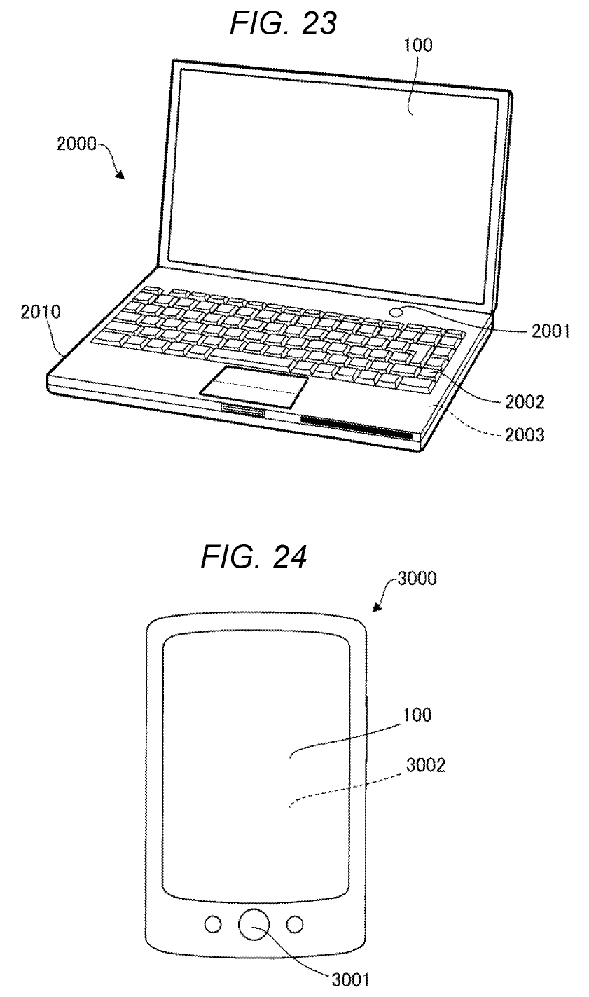

FIG. 23 is a perspective view showing a personal computer 2000 as an example of the electronic apparatus. The personal computer 2000 includes the electro-optical device 100 which displays various images, a main body 2010 provided with a power switch 2001 and a keyboard 2002, and a controller 2003. The controller 2003 includes, for example, a processor and a memory to control operations of the electro-optical device 100.

FIG. 24 is a plan view showing a smartphone 3000 as an example of the electronic apparatus. The smartphone 3000 includes an operation button 3001, the electro-optical device 100 which displays various images, and a controller 3002. The screen content displayed by the electro-optical device 100 is changed in accordance with an operation on the operation button 3001. The controller 3002 includes, for example, a processor and a memory to control the operations of the electro-optical device 100.

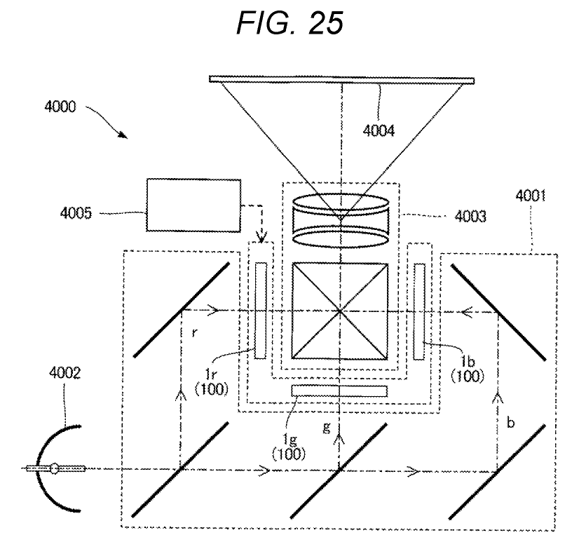

FIG. 25 is a schematic diagram showing a projector as an example of the electronic apparatus. A projection-type display apparatus 4000 is, for example, a three-panel projector. An electro-optical device 1r is the electro-optical device 100 corresponding to a red display color, an electro-optical device 1g is the electro-optical device 100 corresponding to a green display color, and an electro-optical device 1b is the electro-optical device 100 corresponding to a blue display color. That is, the projection-type display apparatus 4000 includes the three electro-optical devices 1r, 1g, and 1b corresponding respectively to the red, green, and blue display colors. A controller 4005 includes, for example, a processor and a memory to control the operation of the electro-optical devices 100.

An illumination optical system 4001 supplies the electro-optical devices 1r, 1g, and 1b respectively with a red component r, a green component g, and a blue component b of light output from an illumination device 4002 which is a light source. The electro-optical devices 1r, 1g, and 1b each function as a light modulator such as a light valve that modulates corresponding monochromatic light supplied from the illumination optical system 4001 in accordance with an image to be displayed. A projection optical system 4003 combines the light output from the electro-optical devices 1r, 1g, and 1b with each other to project the combined light onto a projection surface 4004.

The electronic apparatuses described above each include the electro-optical device 100 described above and the controller 2003, 3002, or 4005. The electro-optical device 100 described above is excellent in reliability. Therefore, by including the electro-optical device 100, it is possible to provide the personal computer 2000, the smartphone 3000, or the projection-type display apparatus 4000 excellent in reliability.

Note that examples of the electronic apparatuses in which the electro-optical device according to the present disclosure is used are not limited to the apparatuses exemplified above, but further include a personal digital assistant (PDA), a digital still camera, a television, a video camcorder, a car navigation system, an in-vehicle display, an electronic organizer, electronic paper, an electronic calculator, a word processor, a workstation, a video phone, and a point of sale (POS) terminal. Further, examples of the electronic apparatuses to which the present disclosure is applied include a printer, a scanner, a copier, a video player, and an apparatus including a touch panel.

The present disclosure has been described above based on the preferable embodiment, but the present disclosure is not limited to the embodiment described above. In addition, the configuration of each element in the present disclosure can be replaced with any configuration that exhibits substantially the same function as that of the embodiment described above, and can be added with any configuration.

Further, in the above description, the liquid crystal display device has been described as an example of the electro-optical device according to the present disclosure, but the electro-optical device according to the present disclosure is not limited thereto. For example, the electro-optical device according to the present disclosure can also be applied to an image sensor or the like.

What is claimed is:

1. An electro-optical device including a pixel region having a pixel electrode and a peripheral region located around the pixel region, the electro-optical device comprising:
a substrate;
a plurality of first transistors located in the pixel region;
a plurality of second transistors located in the peripheral region;
a first insulating layer disposed above the first transistors and the second transistors;
a plurality of first conductive portions located in the pixel region, disposed in the first insulating layer, and separated from each other; and
a plurality of second conductive portions located in the peripheral region, disposed in the first insulating layer, and separated from each other, wherein
in a plan view viewed in a thickness direction of the substrate, an arrangement density of the plurality of second conductive portions in a region occupied by the plurality of second conductive portions is higher than an arrangement density of the plurality of first conductive portions in a region occupied by the plurality of first conductive portions.

2. The electro-optical device according to claim 1, wherein
the plurality of second conductive portions includes a plurality of second contacts provided corresponding to the plurality of second transistors, and
the plurality of second contacts each includes a second columnar portion, and a second upper portion located above the second columnar portion and larger in plane area than the second columnar portion.

3. The electro-optical device according to claim 2, wherein
the plurality of first conductive portions includes a plurality of first contacts provided corresponding to the plurality of second contacts,
the plurality of first contacts each includes a first columnar portion, and a first upper portion located above the first columnar portion and larger in plane area than the first columnar portion, and
an arrangement density of the second upper portions is higher than an arrangement density of the first upper portions.

4. The electro-optical device according to claim 1, further comprising:
a second insulating layer disposed above the first insulating layer so as to be in contact with the first insulating layer;
a plurality of third conductive portions located in the pixel region, disposed in the second insulating layer, and separated from each other; and
a plurality of fourth conductive portions located in the peripheral region, disposed in the second insulating layer, and separated from each other, wherein
in a plan view viewed in the thickness direction of the substrate, an arrangement density of the plurality of fourth conductive portions in a region occupied by the plurality of fourth conductive portions is higher than an arrangement density of the plurality of third conductive portions in a region occupied by the plurality of third conductive portions.

5. The electro-optical device according to claim 4, wherein
the plurality of fourth conductive portions includes a plurality of fourth contacts provided corresponding to the plurality of second conductive portions, and
the plurality of fourth contacts each includes a fourth columnar portion, and a fourth upper portion located above the fourth columnar portion and larger in plane area than that of the fourth columnar portion.

6. The electro-optical device according to claim 5, wherein
the plurality of third conductive portions includes a plurality of third contacts provided corresponding to the plurality of first conductive portions,
the plurality of third contacts each includes a third columnar portion, and a third upper portion located above the third columnar portion and larger in plane area than the third columnar portion, and
an arrangement density of the fourth upper portions is higher than an arrangement density of the third upper portions.

7. The electro-optical device according to claim 5, wherein
the plurality of fourth conductive portions further includes a plurality of conductive portions different in potential from the fourth contacts.

8. The electro-optical device according to claim 5, wherein
each of the plurality of third conductive portions is embedded in a through hole provided to the second insulating layer, and
each of the plurality of fourth conductive portions is embedded in a through hole provided to the second insulating layer.

9. The electro-optical device according to claim 8, wherein
each of the plurality of third conductive portions contains tungsten, and
each of the plurality of fourth conductive portions contains tungsten.

10. The electro-optical device according to claim 9, wherein
the second insulating layer is made of an inorganic material containing silicon.

11. An electronic apparatus comprising:
the electro-optical device according to claim 1; and
a controller configured to control an operation of the electro-optical device.
